(19) United States
(12) Patent Application Publication
(10) Pub. No.: US 2010/0314575 A1
(43) Pub. Date: Dec. 16, 2010

(54) ANTI-ICING SUPERHYDROPHOBIC COATINGS

(76) Inventors: Di Gao, Wexford, PA (US); Andrew K. Jones, Lancaster, PA (US); Vinod K. Sikka, Oak Ridge, TN (US)

Correspondence Address: MEYER UNKOVIC & SCOTT LLP, 535 Smithfield Street, Suite 1300, Pittsburgh, PA, 15222-2315, US

(21) Appl. No.: 12/815,535

(22) Filed: Jun. 15, 2010

Related U.S. Application Data
(60) Provisional application No. 61/187,414, filed on Jun. 16, 2009.

(51) Int. Cl. C09K 3/18

(52) U.S. Cl. 252/70; 977/773

(57) ABSTRACT

Superhydrophobic coating compositions are provided. The compositions comprise nanoparticles between 5-100 nm in size and a polymeric binder. The compositions are effective in preventing ice formation on the surface of various substrates.

### CROSS-REFERENCE TO RELATED APPLICATION

This patent application is a non-provisional application that claims benefit of U.S. provisional application Ser. No. 61/187,414, titled ANTI-ICING SUPERHYDROPHOBIC COATINGS, filed on Jun. 16, 2009, incorporated herein by reference.

### STATEMENT REGARDING FEDERALLY SPONSORED RESEARCH OR DEVELOPMENT

The invention was made with government support under CMMI grant number 0626045 awarded by the National Science Foundation. The United States Government has certain rights to the invention.

### FIELD OF THE INVENTION

Nanoparticle-embedded superhydrophobic coatings are described. The coatings can substantially prevent supercooled water from icing upon impacting a solid surface.

### BACKGROUND OF THE INVENTION

Icing occurs when supercooled water (water in the temperature range of 0° to about −42° C.) droplets strike a solid surface. This naturally occurring phenomenon, known as “freezing rain”, “atmospheric icing” or “impact ice”, may cause disastrous losses.

Supercooled water may form, for example, when water droplets pass through a layer of cold air below the freezing temperature, and freeze instantly upon striking a solid surface. Freezing rain (also referred to as “atmospheric icing”, or “impact ice”), is notorious for glazing roadways, breaking tree limbs and power lines, and causing problems on aircrafts and oil drilling rigs.

Inspired by the “self-cleaning” properties of Lotus leaves, researchers have made significant progress in fabrication of superhydrophobic surfaces, on which water droplets bead up with a contact angle of greater than 150° and drip off rapidly when the surface is slightly inclined. The high contact angle and small hysteresis of water droplets on superhydrophobic surfaces are attributed to a layer of air pockets formed between water and surface irregularities in the substrate. What is needed is a coating that can prevent supercooled water from icing.

### SUMMARY OF THE INVENTION

Accordingly, the present invention provides a nanoparticle-composite coating having the desired properties.

The anti-icing capability is a combined effect of surface superhydrophobicity and heterogeneous nucleation around embedded hydrophobic nanoparticles. The particle size is important to deter ice nucleation in this process. The icing probability increases dramatically when the diameter of the particles increases, even though it has relatively small effect on the superhydro-phobicity of the coatings. This result can be explained by using a classical heterogeneous nucleation theory.

### BRIEF DESCRIPTION OF THE DRAWINGS

The invention is further illustrated by the following drawings in which:

FIG. 1. (A) is a graph showing the probability of ice formation and the advancing and receding angles of water droplets on each superhydrophobic coating as a function of the size of the hydrophobic particles. (B) Scanning electron microscopy image of the superhydrophobic coating made by mixing a polymer binder with 50 nm silica particles. Scale bar, 1 μm (C) Schematic cross-sectional profile of water in contact with superhydrophobic surfaces. (D) The ratio of free-energy barrier (f) for nucleation around a spherical particle relative to that in the bulk versus the particle radius (R) divided by the radius of the critical nucleus (r_{c}). (E) One side of an aluminum plate without the superhydrophobic coating is completely covered by ice after a natural occurrence of “freezing rain”. Scale bar, 3 cm. (F) The other side of the aluminum plate with a superhydrophobic coating has little ice after the “freezing rain”. Scale bar, 3 cm.

FIG. 2 (A) is a scanning electron microscopy image of a coating made with 20 nm particles. Scale bar, 1 μm. Inset, transmission electron microscopy image (scale bar, 50 nm). (B) SEM image of a coating made with 20 μm silica particles. Scale bar, 100 μm. (C) A satellite dish antenna after an occurrence of “freezing rain”. The left side is untreated and is completely covered by ice, while the right side is coated with the superhydrophobic coating and has no ice. (D) A close view of the area labeled by a red square in (C), showing the boundary between the coated (no ice) and uncoated area (ice) on the satellite dish antenna. Scale bar, 3 cm.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The coating compositions of the invention comprise 20-40% by weight nanoparticles, 60-80% by weight polymer binder. Optionally the composition can include a solvent in amounts between 10-30% by weight, and can also optionally include an initiator, present in amounts ranging from 1-10%. More preferably the compositions will comprise 20-30% by weight nanoparticles and 70-80% by weight polymer binder, and most preferably 20-25% by weight nanoparticles and 75-80% by weight polymer binder.

Preferably, the nanoparticles used in compositions of the present invention are hydrophobic. Examples of suitable hydrophobic particles include, but are not limited to, silica, alumina, titanium oxide, zirconium oxide, antimony oxide, zinc oxide, tin oxide, indium oxide, cerium oxide, mullite (alumina silicate); other oxides such as iron oxide, nickel oxide, oxides of refractory metals such as molybdenum, niobium, and tungsten, and complex oxides created from co-precipitation or oxidation of complex oxides are also possible.

Preferably, the nanoparticles used in the compositions of the invention will be surface-modified with compounds that make the surface of the particles more hydrophobic. Examples of such compounds include organosilanes, such as polydimethylsiloxane, hexamethyldisilnzane, octyltrimethoxysilane, and dimethyldichlorosilane. Other compounds besides organosilanes that can be used include, for example, any molecule that possesses a hydrophobic chain, e.g. alkyl chain or fluorocarbon chain.

These particles can be produced by numerous methods and can be of a variety of shapes including spherical, elongated, asymmetric, fibrous and various combinations of these.

Preferably, the nanoparticles of the present invention are between 5-100 nm in size, more preferably equal to or above 5, 6, 7, 8, 9, 10, 11, 12, 13, 14, 15, 16, 17, 18, 19, 20, 21, 22, 23, 24, 25, 26, 27, 28, 29, 30 nm in size, and with an upper limit more preferably equal to or less than 90, 80, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40 nm in size. A preferred size range for the nanoparticles is 20-50 nm.

Any suitable polymeric binder can be used, so long as it has the ability to react with the surface to be coated with the compositions of the invention. For example, for metal surfaces a good binder could be a polymer that includes an etchant that attaches to the metal surface by etching the surface, such that the metal atoms from the etched surface form bonds with the polymer. Some binders can also form very good mechanical bonds, through the polymerization process that leaves the binder in compression. Examples are thermoplastics and thermosets. These binders do require thermal energy for polymerization. Another set of binders are polyurethanes that polymerize at ambient temperature and tend to produce very strong bonds with the substrates.

Additional examples of suitable binders include binders prepared from silicone resins and acrylate polymers. One skilled in the art can determine a suitable binder based on the type of article to be coated. Preferably, the binder is cured at room temperature, although elevated temperature can be used to speed up the curing.

After the binder has cured, it is mixed via simple mixing at room temperature with the nanoparticles in the above described ratios. A suitable non-aqueous solvent can be used to bring the mixture to the desired viscosity. Examples of suitable solvents include organic solvents, such as toluene and acetone. The coating is applied to a substrate in the desired thickness and allowed to further cure at room temperature.

The coating compositions described herein can be applied to a substrate by any suitable method, for example by spraying, dipping, spin coating, flow coating, meniscus coating, capillary coating, roll coating, and painting. They can be applied to new components on the production floor or they can be applied in the field to existing components.

The mixture according to the invention is applied to the substrate in a single layer or multiple layers if desired, in any desired thickness. The coatings according to the invention typically have a thickness ranging between 50 nm to several micrometers. Preferably the thickness is between 5 nm and 50 μm, more preferably between 10-30 μm.

In addition to room temperature curing, other methods such as heating by a variety of processes can speed up the curing process. These include: hot air, oven curing, UV curing, and infrared curing. Such methods can reduce the curing times to minutes from hours that it takes to cure at room temperature.

The anti-icing superhydrophobic coatings of the invention can be used on a variety of articles, including, for example, overhead power transmission cables; cell phone towers; satellite dishes; roofing shingles; posts supporting street lights; railings around residential and commercial installations; ship decks and siding; bridges gutters around housing and residential buildings; windmill blades; ceramic insulators used for high power transmission lines; helicopter blades; airplanes wings and other components; rail road cars for sub-zero weather regions; and gate valves for water dams; and vehicles such as cars, trucks and the like.

Substrates to which the coatings can be applied include, but are not limited to,

metals, including aluminum and its alloys; steels; galvanized steel; stainless steels; copper and its alloys; titanium and its alloys; plastics, wood and textiles.

### Example

### Materials

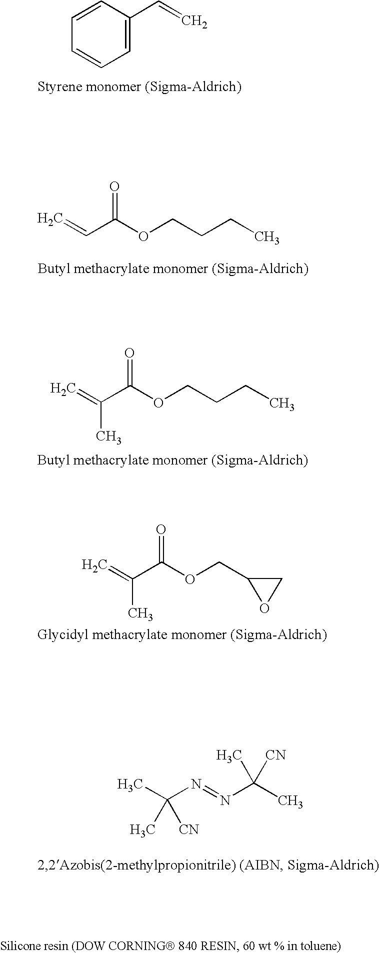

Organosilane-modified hydrophobic silica particles in varied diameters, 20 nm, 50 nm, 100 nm, 1 μm, 10 μm, and 20 μm, are from Ross Technology Corporation.

Methods

Synthesis of Acrylic Polymer Resin

Acrylic polymer was synthesized by free radical polymerization of styrene, butyl acrylate, butyl methacrylate and glycidyl methacrylate in toluene using azodiisobutyronitrile (AIBN) as the initiator. In a three-necked round-bottomed flask equipped with a magnetic stirrer, a condenser, an addition funnel, and a thermometer, 3.13 g of styrene, 1.92 g of butyl acrylate, 12.32 g of butyl methacrylate, 4.25 g of glycidyl methacrylate, and 100 ml of toluene were mixed. A solution of 0.2 g AIBN in 2.5 ml toluene was added into the flask. The reaction mixture was then heated to 85° C. and stirred isothermally for 3 h. After that, the same amount of AIBN toluene solution was added into the flask, and the mixture was stirred for another 3 h. At the end of the reaction, the mixture was cooled at room temperature. The resulting acrylic polymer was precipitated in hexane and filtered, and then dried under vacuum at 40° C. for 24 h.

Preparation of the Polymer Binder

A polymer binder was prepared by mixing 2.2 g of the synthesized acrylic polymer, 1.2 g of silicone resin (DOW CORNING® 840 RESIN, 60 wt % in toluene), 1.3 g toluene, and 0.6 g acetone. The binder can be cured either at room temperature within 12 h or at 80° C. within 2 h. During the curing process, the reactive glycidyl groups on the acrylic polymers crosslink with the silicone resin. The static water contact angle of the cured binder is about 107°.

Preparation of the Superhydrophobic Coating

The superhydrophobic coatings were made by mixing about 2.5 g of the organosilane-modified silica particles in varied diameters (20 nm, 50 nm, 100 nm, 1 μm, 10 μm, and 20 μm) with 5 g of the polymer binder, 75 g toluene, and 15 g acetone. They were applied on A1 plates by a spray gun at a pressure of about 30 psi and cured at room temperature for 12 hr. The thickness of the cured coating is about 20 μm.

Contact Angle Measurement

The water contact angle was measured by using a VCA-OPTIMA drop shape analysis system (AST Products, Inc.) with a computer-controlled liquid dispensing system and a motorized tilting stage. Water droplets with a volume of 4 μl were used to measure the static WCA. The advancing and receding angles were recorded during expansion and contraction of the droplets induced by placing a needle in the water droplets and continuously supplying and withdrawing water through the needle. The sliding angle was measured by tilting the stage and recorded when the droplet began to move in the downhill direction. The experiments were performed under normal laboratory ambient conditions (20° C. and 30% relative humidity). Each contact-angle measurement was repeated 3 times.

Icing Experiments Using Laboratory-Made Supercooled Water

Supercooled water was prepared by storing bottled pure water in a −20° C. freezer for 3 h. The coated and uncoated A1 plates were also stored in the −20° C. freezer for 3 h before the experiments and were tilted at an angle of about 10° to the horizontal plane during the experiments. Supercooled water was poured onto the A1 plates about 5 cm above the plates. Each experiment was repeated 20 times to obtain the probability of ice formation on different samples.

Icing Experiments by Using Naturally Occurring “Freezing Rain”

One side of an A1 plate (10 cm×10 cm) was coated with a superhydrophobic coating made with 50 nm organosilane-modified silica particles, while the other side was untreated. A hole of about 1 cm in diameter was drilled near one edge of the plate and a cotton thread was used to hang the A1 plate outdoors. Half of a commercial satellite dish antenna (SuperDish Network) was coated with the same coating while the other half was left untreated. Both the dish antenna and the A1 plate were placed outdoors in a typical whether condition (about −10° C.) of Pittsburgh, Pa., in January for 7 days before the freezing rain occurred on the night of Jan. 27, 2009.

Calculation of the Area Fraction of the Solid Surface that Contacts Liquid

The correlation between the apparent contact angle (θ_{rough}) and the intrinsic contact angle (θ_{flat}) has been described by the Cassie-Baxter equation

cos θ_{rough}=φₛ cos θ_{flat}−(1−φₛ), 1)

where φₛ is the area fraction of the solid surface that contacts liquid.

Estimating the Radius of Critical Nucleus and the Effect of Particle Size on the Free Energy Barrier of Ice Formation by a Classical Nucleation Theory

A classical heterogeneous nucleation theory is used to estimate the radius of critical nucleus and the effect of particle size on the free energy barrier of ice formation (2). The free energy barrier for heterogeneous nucleation around a spherical particle of radius R is reduced by a factor (f) in comparison with that for homogeneous nucleation. The effect of the particle size and water-particle contact angle (θ₀) on the free-energy reduction can be calculated by (2):

$$f = \frac{1}{2} + \frac{1}{2} {( \frac{1 - mx}{w} )}^{3} + \frac{{x}^{3}}{2} [ \begin{matrix}2 - 3 ( \frac{x - m}{w} ) + \\ {( \frac{x - m}{w} )}^{3}\end{matrix} ] + \frac{3 {mx}^{2}}{2} ( \frac{x - m}{w} - 1 ) ,$$

where x=R/r_{c}, r_{c} is the radius of the critical nucleus, m=cos θ₀ with θ=110° the hydrophobic silica particles, and w=(1+x²−2xm)^{1/2}. The radius of the critical nucleus is estimated from:

$${r}_{c} = - \frac{2 γ v}{Δ G} ,$$

where γ≅0.034 J/m² is the water-ice interfacial tension (3), ν≅1.8×10⁻⁵ m³/mol is the water molar volume, and ΔG≅−C_{P}T[ln(T/Tₘ)+T/Tₘ−1]. In this work, T=253.15, K, the ice melting temperature is Tₘ=273.15 K, and water heat capacity is C_{P}≅75.3 J/mol·K.

Results

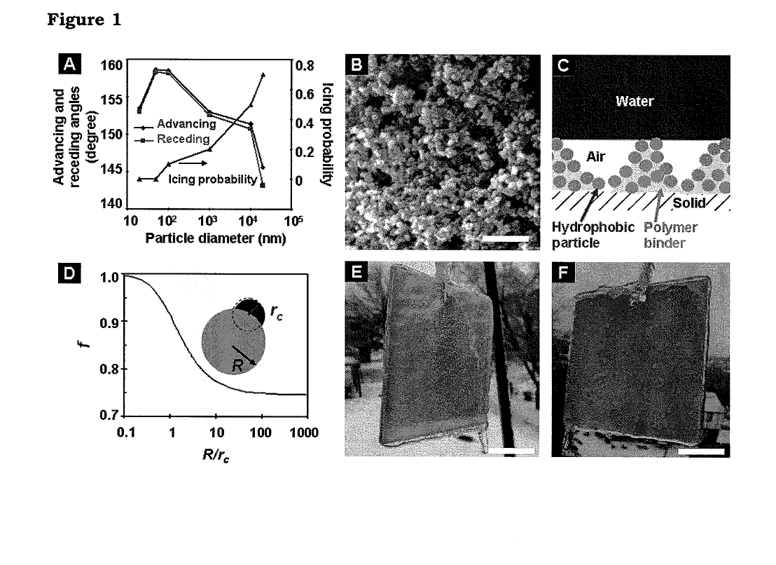

FIG. 1A plots the probability of ice formation and the advancing and receding angles of water droplets on each coating as a function of the diameter of the silica particles used in the coating. The coatings made by using particles with diameters of 20 nm, 50 nm, 100 nm, 1 μm, and 10 μm are all superhydrophobic with insignificant difference in the advancing and receding angles. However, the probability of ice formation on these coatings changes significantly—ice does not form on samples with 20 and 50 nm silica particles, but the probability of forming ice increases significantly as the particle diameter is increased beyond 50 nm.

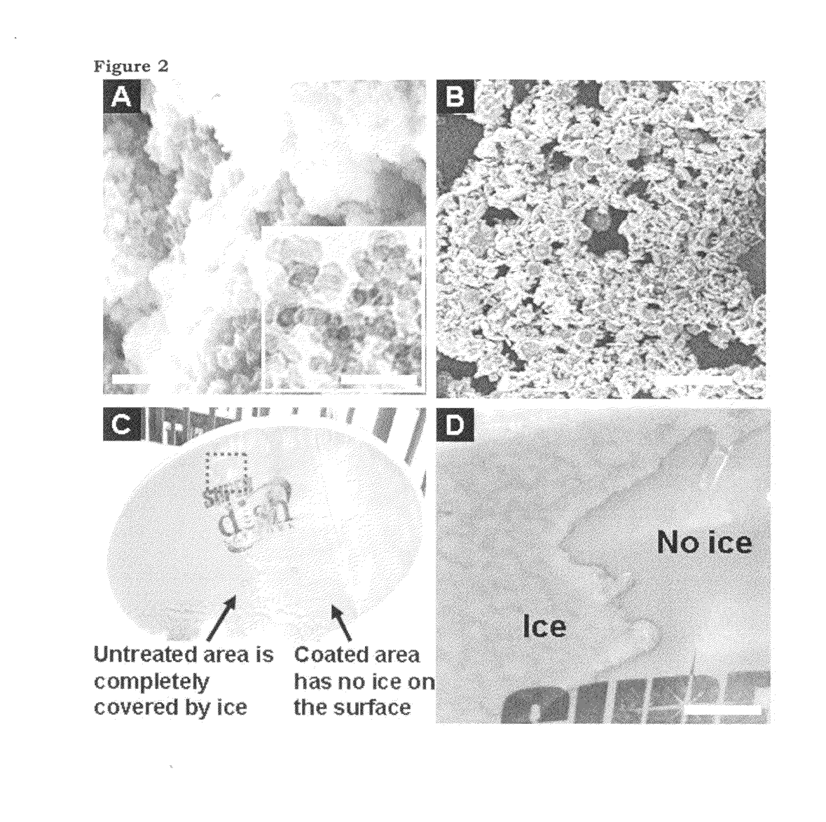

A scanning electron microscopy image of the coating embedded with 50 nm particles is shown in FIG. 1B (coatings embedded with 20 nm and 20 μm particles are shown in FIGS. 2A-2B). As schematically shown in FIG. 1C, water on such coatings is primarily in contact with air pockets. According to the Cassie-Baxter equation, the large contact angle implies that less than 15% of the projection area is in direct contact with water. When supercooled water impacts such surfaces, the heterogeneous nucleation process starts from the contact between water and particles. As a result, the nucleation process is directly related to the particle size. FIG. 1D shows the effect of particle radius (R) on the free energy barrier of the heterogeneous nucleation calculated from a classical nucleation theory (4), where the radius of the critical nucleus (r_{c}) is 21.6 nm (see Supporting Material) under our experimental conditions. The energy barrier falls monotonically as R increases. Because the icing probability is an exponential function of the free energy barrier, the dramatic increase of the icing probability with the particle size can be readily explained.

The anti-icing property of the superhydrophobic coating has also been tested in naturally occurring “freezing rain”. FIGS. 1E and 1F compare two sides of an A1 plate: one side is coated with the superhydrophobic coating and the other side is untreated. After an occurrence of “freezing rain”, the side with the superhydrophobic coating has little ice, while the untreated side is completely covered by ice. Similar results have been obtained on a commercial satellite dish antenna (FIGS. 2C-2D).

Whereas particular embodiments of this invention have been described above for purposes of illustration, it will be evident to those skilled in the art that numerous variations of the details of the present invention may be made without departing from the invention as defined in the appended claims.

What is claimed is:

1. A superhydrophobic coating composition comprising nanoparticles between 5-100 nm in size and a polymeric binder.

2. The superhydrophobic coating composition of claim 1, wherein the water contact angle of the coating is greater than or equal to 150°.

3. The superhydrophobic coating composition of claim 1, wherein the nanoparticles are between 5-50 nm in size.

4. The superhydrophobic coating composition of claim 1, wherein the polymer binder is prepared from silicone resin and an acrylic polymer.

5. The superhydrophobic coating composition of claim 1, wherein the nanoparticles comprise 20-40% by weight of the composition and the binder comprises 60-80% by weight of the composition.

6. A method of providing resistance to formation of ice on a substrate, the method comprising the step of coating the substrate with the composition according to claim 1.

7. A superhydrophobic coating composition comprising nanoparticles between 5-100 nm in size and a polymeric binder, wherein coating inhibits formation of ice on a substrate coated with the coating.
